(19) United States
(12) Patent Application Publication
(10) Pub. No.: US 2008/0114626 A1
(43) Pub. Date: May 15, 2008

(54) System and Method for Capturing Process Instance Information

(75) Inventors: Stefan A. Baeuerle, Malsch (DE); Roger W. Kilian-Kehr, Darmstadt (DE); Meinert Holger, Muehlhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/560,014

(22) Filed: Nov. 15, 2006

(51) Int. Cl. G06Q 10/00; G06F 17/30

(52) U.S. Cl. 705/7

(57) ABSTRACT

A system and method for capturing and information about a process instance in a business system is provided. A unique process instance identifier may be assigned to each business object created, used, or modified during execution of the process intnce. The identifier may then be used to monitor or analyze the process instance during execution or at a later time. Since each process instance is associated with a single process instance identifier, the identifier may be used to filter business objects unrelated to a process instance of interest to a user.

### CROSS-REFERENCE TO RELATED APPLICATIONS

This application is related to co-pending U.S. application No. ______, filed ______ (Attorney Docket No. 11884/497201).

### BACKGROUND

When mapping business processes to technical processes, a business system may create and use a variety of data objects. As a business process is performed, many such data objects may be created and manipulated. For example, when a purchase contract is implemented in a business system, multiple purchase orders, customer invoices, and other types of business objects may be involved. While a specific set of business objects may be related in a workflow (i.e., a specific set of steps in a process), it may be difficult or impossible to view execution of the entire business process within the system. Efforts to view or manipulate a process instance may further be complicated when business objects are involved in multiple process instances, or when a business system spans multiple organizations such as suppliers, customers, and manufacturers.

### BRIEF DESCRIPTION OF THE DRAWINGS

FIG. 1 shows a process instance with a process instance identifier assigned to business objects according to an embodiment of the present invention.

FIG. 2 is a schematic diagram showing the structure of a process instance identifier assigned to a node in a business object according to an embodiment of the present invention.

FIG. 3 shows a message for propagating a process instance identifier according to an embodiment of the present invention.

FIG. 4 is a schematic diagram of messages storing process instance identifiers sent between components of a business system according to an embodiment of the present invention.

FIG. 5 shows execution of process instances and analysis of a process instance according to an embodiment of the present invention.

FIG. 6 shows an exemplary process for assigning a process instance identifier to a business object according to an embodiment of the present invention.

FIG. 7 shows an exemplary process for constructing a process instance using process instance identifiers according to an embodiment of the present invention.

FIG. 8 shows a business system implementing process instance identifiers according to an embodiment of the present invention.

### DETAILED DESCRIPTION

Embodiments of the present invention provide systems and methods for analyzing and/or tracking process instances within a business system by use of a process instance identifier. A process instance may be defined by a chain of business objects that results from the execution of one or more business scenarios. For example, a process instance may include manufacturing orders, deliveries, invoices, and other items associated with a purchase order. A process instance may include multiple workflows and/or business objects from a variety of workflows. For example, during execution of a purchasing contract, each purchase order generated by the contract may involve multiple workflows such as approval, processing, and other procedures related to each order. The process instance associated with the purchasing contract may include all the business objects created and/or manipulated for each purchase order. As used herein, a “Universal Process Identifier” (UPI) refers to an identifier associated with a business process instance. At the beginning of a process instance, a new UPI may be associated with the first business object created in the instance. The UPI may then be propagated to any successor business objects of the initial object. By propagating the UPI through the business objects involved in the process, each business object involved in execution of the process instance may be identified and made available for analysis.

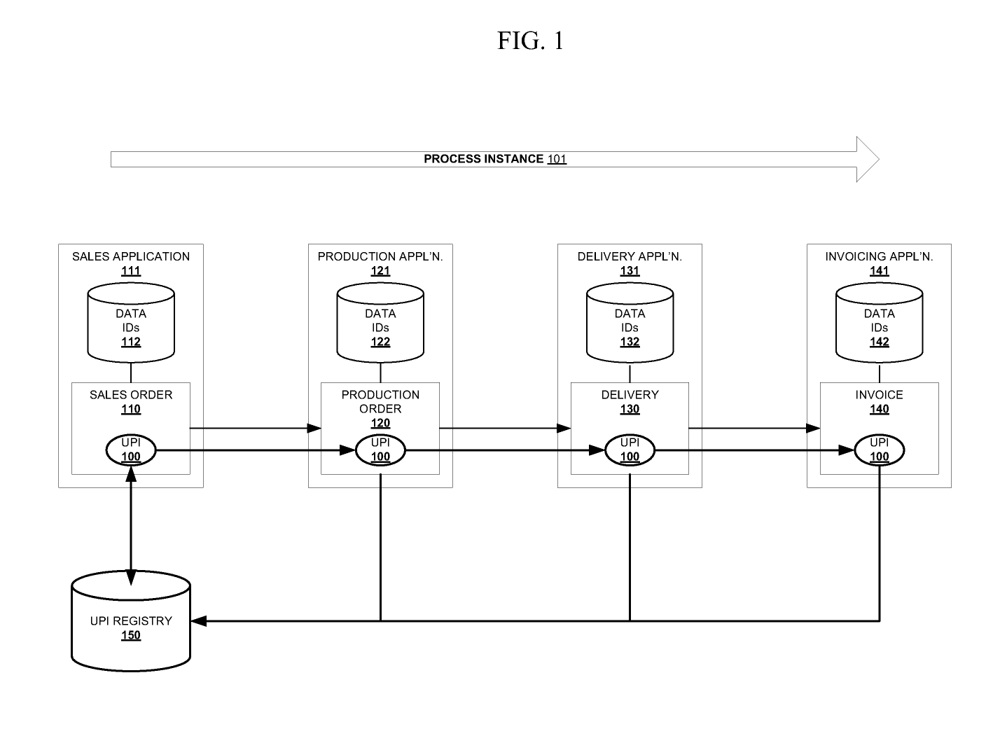

FIG. 1 shows an exemplary business system which may contain multiple applications directed to specific functions such as sales 111, production 121, delivery 131 and invoicing 141. The applications may execute on computer servers (not shown). Each application may generate its own data and processes 112, 122, 132, 142, respectively, which may be internal to the application (i.e., not shared between applications). When the applications execute processes in a business system, business objects may be created that store and manipulate data within the application. Each business object may be assigned a unique identifier within the application. For example, a sales order 110 may have a unique identifier to distinguish it from other business objects within the sales application 111. Each application typically stores a record of the internal identifier assigned to each business object, such as in the internal database 112, 122, 132, 142 used by each application. In this regard, the structure and operation of enterprise management systems are well known.

The process instance 101 shown in FIG. 1 may be, for example, a process used in receiving and processing a customer order. When a sales order is received, a sales order business object 110 may be created in the business system. Since the sales order does not have a predecessor business object (i e., a business object that must be created before the sales order business object can be created, or that generated the sales order business object), a new UPI 100 is created and assigned to the sales order object. A record of the UPI may also be stored in a UPI registry 150. The specific format and/or value of the UPI 100 may be determined by the business system after consulting the registry 150. For example, it may be desirable to assign sequential UPIs to process instances as they are executed. In such a case, the business system may consult the UPI registry 150 to determine the next sequential UPI to be assigned. In an embodiment, the internal identifier assigned to the initial business object in a process instance (such as the sales order 110 in FIG. 1) may be used as the UPI for the process instance.

As the process instance 101 is executed by the business system, the UPI 100 may be propagated to successor business objects. In the example, the sales order 110 generates a production order 120. When the production order 120 is generated, the UPI 100 may be assigned to the production order. Similarly, the UPI may be assigned to each subsequent business object, such as a delivery object 130 and an invoice object 140. Each time the UPI is propagated to a successor business object, a record of the UPI and the business object to which it is assigned may be stored in the UPI registry 150. The registry may be used for later analysis, such as reconstructing a business process instance from a selected business object or displaying business objects generated during execution of a selected process instance.

In an embodiment, each UPI may be unique within the business system, i.e., each process instance may be associated with a single UPI, and/or each UPI may be associated with a single process instance. However, the same UPI may, and generally will be assigned to multiple business objects when each business object is part of a process instance associated with the UPI In some cases a business object may be associated with multiple UPIs. For example, when a successor business object stores information related to two predecessor business objects, each of which is part of a separate process instance, the successor business object may store the UPI assigned to each of the predecessor objects.

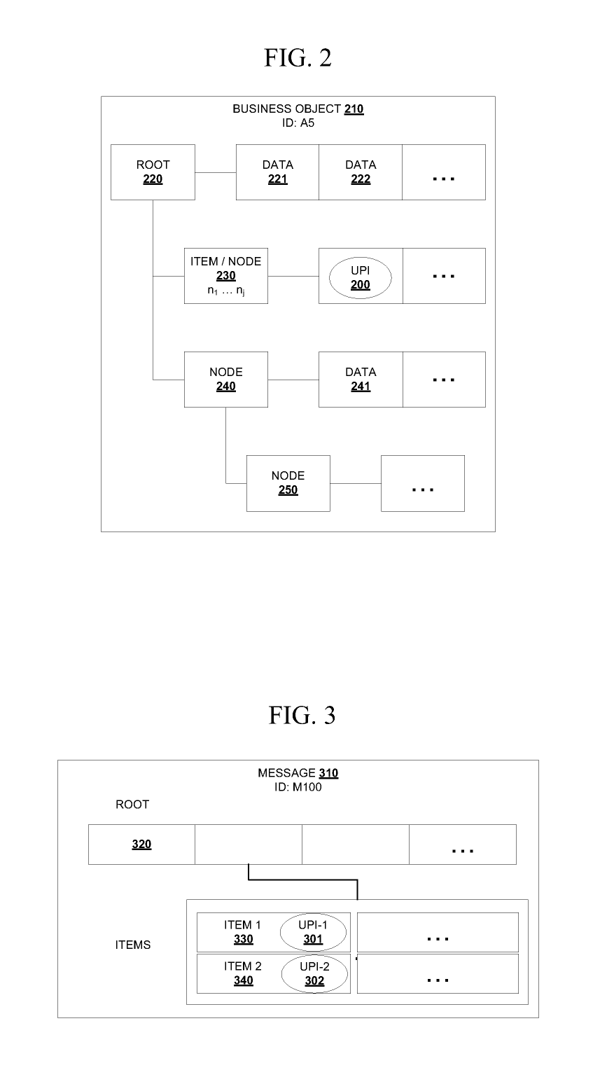

Process instances may be more complex than the example described with reference to FIG. 1 For example, a business object type may have a hierarchical structure involving multiple nodes as shown in FIG. 2 A business object 210 may have a root node 220 and various levels of child nodes 230, 240, 250 Each node may have data 221, 222, 241, such as attributes of the node, associated with it. Each root node may include different types of items, such as n nodes of type x, and m nodes of type y. Each type may be assigned a UPI, i.e., one UPI may be assigned for all nodes of type x and a second UPI for all nodes of type y. Each instance may also be assigned a UPI. In the example shown in FIG. 2, a UPI 200 is assigned to “item” nodes. The UPI may be stored as an attribute of the corresponding node. As shown in the example, a business object may have an identifier (“A5” in FIG. 2) within the application that generates the business object. Such identifiers are typically internal to the application, and are not sent or shared between applications. In contrast, in embodiments of the invention UPIs may be transferred from a predecessor business object to a successor business object when the objects are part of the same process instance.

Various methods may be used to assign UPIs. For example, a single UPI may be assigned to each node of the same type, i.e., the UPI of each item node nⱼ is the same: UPI(nⱼ)=UPI(nⱼ). As another example, a UPI may be assigned to each item node: UPI (nⱼ)≠UPI(nⱼ) for i≠j For example, in cases where the business process is controlled, it may be advantageous to assign UPIs based on items of a particular type When the second exemplary method is used, various mechanisms may be applied to allow tracking of process instances and to maintain consistency among UPIs. If a business object may have, or is known to have multiple predecessors (such as a purchase order generated from multiple purchase requests), a UPI may be assigned to each item node, or to the nodes of another level in the hierarchy if the node's predecessor is unknown. In general, business objects and nodes may be treated in a similar fashion when assigning and manipulating UPIs. Unless specifically indicated otherwise herein, the term “business object” therefore may refer to a business object or to a node stored within a business object The assignment of UPIs is further described below.

Business systems may employ a number of separate components or sub-systems, such as customer relations management, supply chain management, and other systems. Some components may be run by business partners, and may be built on third-party systems that interface with the business system. Such distributed systems may communicate by transmitting and receiving messages in a standardized format. The structure of an exemplary message providing information about items in a business object is shown in FIG. 3. A message 310 may contain various items 320, 330, 340, each of which may have associated properties, attributes, etc. As previously described, the message 310 may be assigned an identifier (“M100” in FIG. 3) within the system. For example, a record of each message may be stored in a database, where the ID of the message identifies its location in the database. However, such identifiers typically are not propagated to the application or business object receiving the message. In an embodiment of the invention, a UPI may be propagated via a message, allowing the sending and receiving business objects to be linked to the same process instance. To propagate UPIs 301, 302 associated with each item between systems or components, the UPIs 301, 302 assigned to each item 330, 340, respectively, may be stored as an attribute or property of the associated item. When a remote system receives such a message, it may further propagate the UPIs to additional business objects.

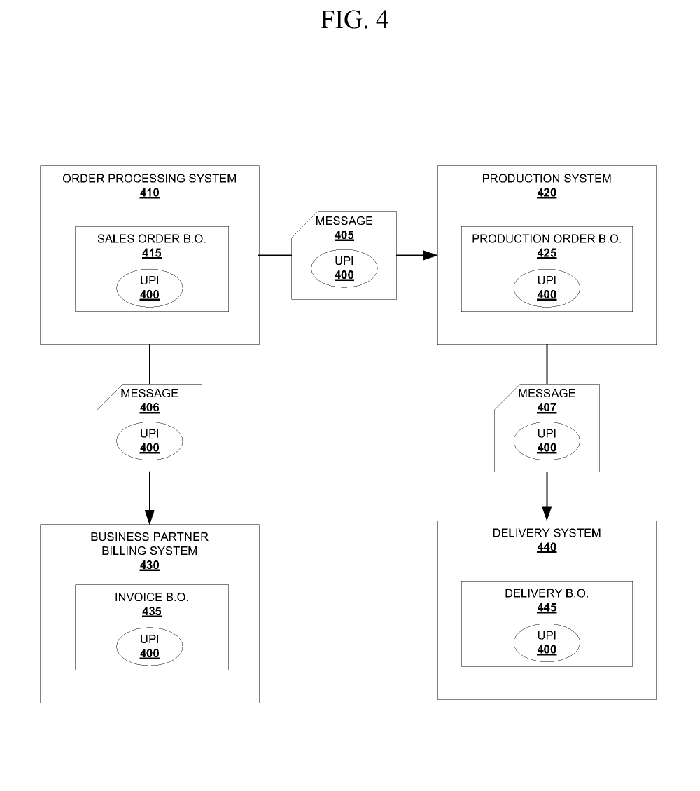

FIG. 4 shows an example of messages used to propagate a UPI between systems. An order processing system 410 may receive an initial order from a customer, and subsequently create a sales order business object 415 Since the sales order does not have a predecessor business object, a new UPI 400 may be created and assigned to the business object. As part of the process instance, a message 405 may be sent to a production system 420, which may generate a production order 425. The message may include the UPI 400, allowing the UPI to be associated with the production order 425. At a later point in the process instance, a message 407 may be sent to, for example, a delivery system 440, which may create a delivery business object 445. The message 407 may include the UPI 400 previously included in the message 405 sent to the production system; the UPI may then be assigned to the delivery business object 445 to indicate that it is part of the associated process instance. Similarly, a message 406 may be sent to a business partner's system 430, such when billing is provided by a third party. The message 406 may include the UPI 400, allowing the UPI to be propagated to business objects 435 created in the business partner's system.

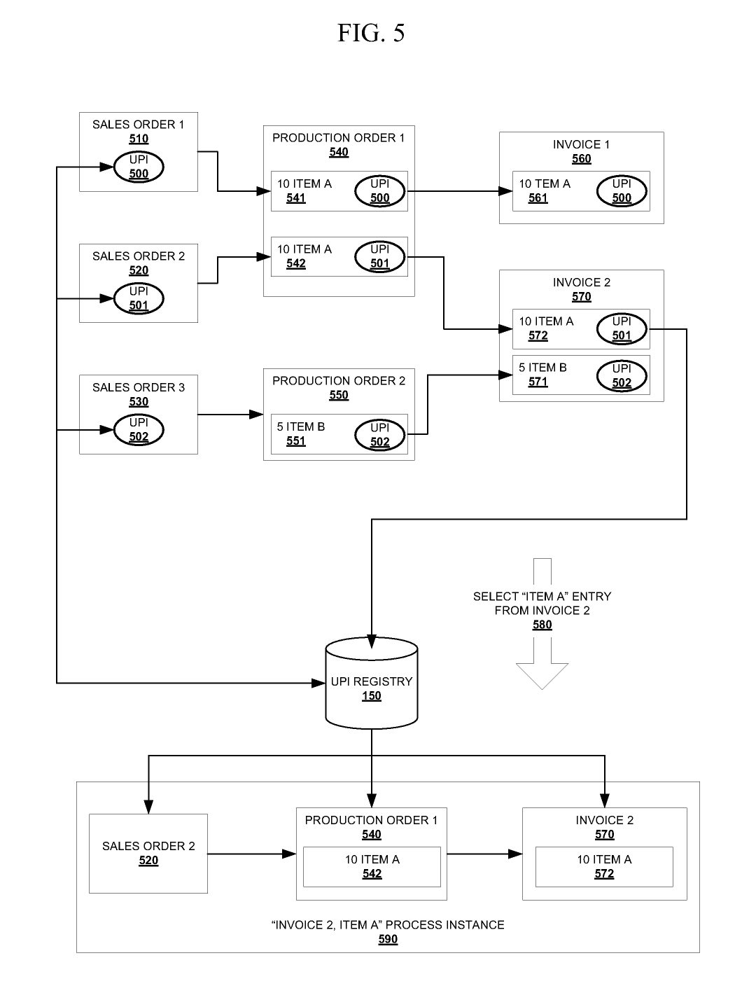

When a UPI is propagated through each business object involved in a process instance, the process instance may be reconstructed for analysis as shown in FIG. 5. The example shown in FIG. 5 may represent a simplified process instance or set of process instances related to purchase, production, and delivery of an order. The processes shown are intended to be illustrative, and may not represent every element or step of a real process. For example, some systems and procedures that would be present in a real process may be omitted for clarity. In the example shown, a first customer may place an order for 10 of “item A,” resulting in the creation of a first sales order 510. When the sales order is created, a new UPI 500 may be assigned. If a UPI registry 150 is used, the assigned UPI 500 may be determined by and/or stored in the UPI registry 150 as previously described. A second customer may place an order for 10 “item A” and 5 “item B,” resulting in the creation of two sales orders 520, 530 and associated UPIs 501, 502, respectively. In some cases, the two orders 510, 520 for “item A” may be combined into a single production order 540 (i.e., a single order for 20 “item A” to be produced). Each UPI 500, 501 is propagated to an appropriate item 541, 542 in the production order business object 540. The order 530 for “item B” may similarly generate a production order 550 having a single item 551. The UPI 502 that was created and assigned to the “item B” sales order 530 may be propagated to the item 551 in the production order 550.

After the ordered products have been manufactured, invoice business objects 560, 570 may be created. One invoice may be created for each customer. That is, a first invoice 560 may be created for the first customer who placed a single order for 10 “item A,” and a second invoice 570 may be created for the second customer who ordered 10 “item A” and 5 “item B.” The UPI 500 associated with the first order may be propagated to an item in the first invoice 560. Similarly, UPIs 501, 502 may be propagated to the two items 572, 571, respectively, in the second invoice 570. At each step of the processes illustrated in FIG. 5, the appropriate UPI may be propagated from a predecessor business object or node to a successor business object or node.

FIG. 5 shows three process instances, each instance being associated with a UPI 500, 501, 502. It may be desirable for a user of the system to track a process instance as it occurs in the business system or to analyze a process instance at a later time. For example, the process instance associated with an item in an invoice business object may be of interest, such as when a customer disputes an entry on the resulting invoice. A user may select (580) an item of interest, such as the “item A” node 572 in the second invoice business object 570. The system may then reconstruct the process instance 590 associated with the selected item 572, for example by selecting each business object and/or node that is assigned the same UPI 501 as the selected item. For example, if a UPI registry is used, each entry in the registry 150 having a record associating a business object or node with the UPI 501 of the selected item may be retrieved and presented in order. As another example, the system may iteratively “step” through the process instance. Using this method, the selected item 572 is examined to determine the assigned UPI 501 and the predecessor business object or node 542. The predecessor is then similarly examined, until the initial business object (i.e., one having no predecessor) is reached. A similar method could be used if, for example, a business object such as the “item A” node 501 was initially selected. The process instance could then be assembled by iteratively examining the selected object 501 and each of its predecessor and successor objects.

Once each business object or node involved in the process instance has been selected, the instance 590 associated with the selected item may be displayed or provided for manipulation and/or analysis. A schematic view 590 may be displayed to the user, which may include relationships between business objects. For example, predecessor/successor relationships may be displayed by directed arrows. Other information and relationships may be displayed, and a variety of formats may be used. The system may provide only those business objects and/or nodes directly involved in the process instance, as shown in FIG. 5, or it may provide all business objects and/or nodes in each related process. For example, if the “invoice 2, item A” node is selected as previously described, the second production order 550 and/or the first “item A” node 541 may also be provided. Providing related business objects and/or nodes may be useful to provide information about a selected node's relationship to a larger variety of process instances, business objects and/or nodes.

The method for analyzing a process instance shown in FIG. 5 may be advantageous over other methods of analyzing a process instance. For example, in some business systems each business object may store an indication of its predecessor and successor business objects. The system could thus iteratively examine each business object to select predecessor and successor objects and construct a process instance. However, such methods may be time and/or computationally expensive. For example, in the process instances shown in FIG. 5, Invoice 2 (570) has two predecessor objects—Production Order 1 (540) and Production Order 2 (550). Production Order 1 (540) in turn has two predecessor objects—Sates Order 1 (510) and Sates Order 2 (520). Reconstructing a specific process instance may therefore require a thorough analysis of the predecessor-successor relationships between the various business objects, the use of each business object in a typical process, and the specific role of each business object in each possible process instance. When a process instance identifier according to an embodiment of the invention is used, such analysis may be reduced or removed. Embodiments of the invention therefore may allow for process instances to be constructed and analyzed relatively easily and quickly.

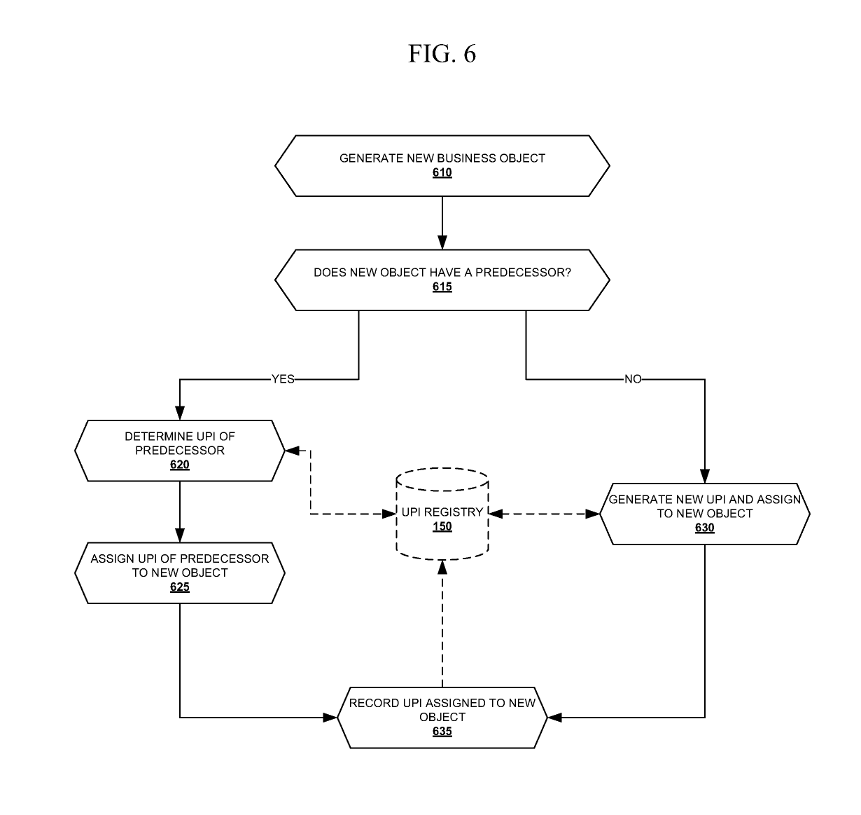

FIG. 6 shows an exemplary process for creating and assigning UPIs according to an embodiment of the invention. As part of a process instance, a new business object may be generated 610. In a system implementing process instance identifiers, the system may determine whether the new object has a predecessor 615. If there is a predecessor object, the UPI of the predecessor object may be selected and assigned to the new object 620, 625. If there is no predecessor object, such as when the new business object is the initially-created object in a process instance, a new UPI may be generated and assigned to the new object 630. In each step 620, 630, a UPI registry 150 may be used to determine the UPI assigned to a predecessor object or the appropriate UPI to generate and assign to the new business object. Once the appropriate UPI is determined and assigned to the new business object, a record of the UPI and information about the business object may be stored in the system 635, such as in the UPI registry 150.

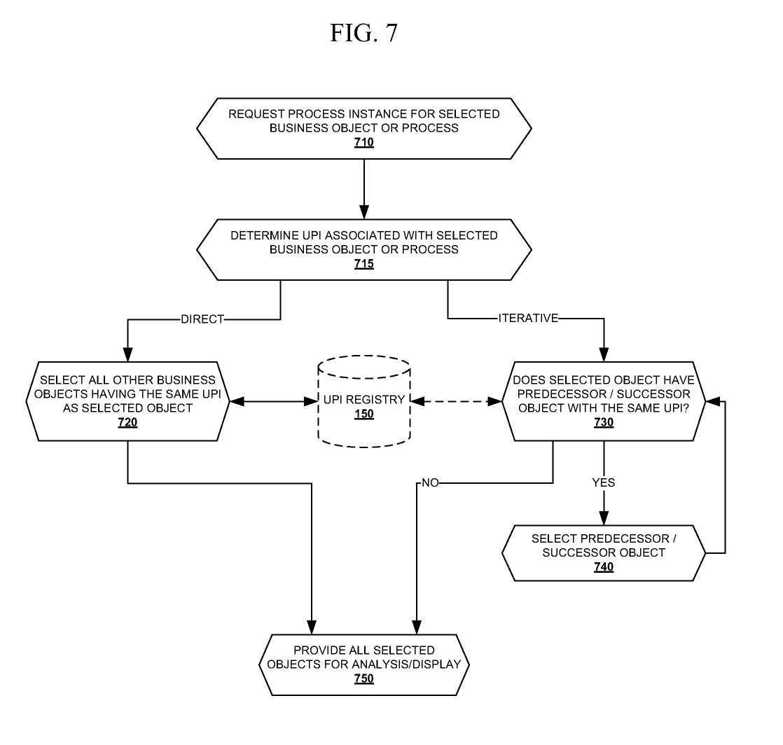

FIG. 7 shows an exemplary process for analyzing a process instance using UPIs according to an embodiment of the invention. A user of the business system may select a business object or process for which the process instance details are desired 710. For example, the user may wish to see the process instance resulting from a leave request submitted by an employee. As another example, the user may indicate a specific process, such as “sell from stock.” Such processes may be, for example, listed in a regular report generated by the system or requested by the user. In response to the user's request to view or analyze a process instance, the UPI of the selected business object or process may be determined 715. As previously explained, the process instance may be constructed directly, such as by selecting other objects having the same UPI, or iteratively, by examining each objects predecessor(s) and/or successor(s).

If a direct method is used, each object having the same UPI as the selected object or having the UPI associated with the selected process instance may be selected 720. For example, a UPI registry 150 may be queried to determine each business object associated with the UPI. Once the associated business objects have been selected, they may be provided to the user 750. The business objects or information about the objects may be provided in a variety of formats, such as a graphical representation of the process instance, a flowchart showing steps in the process, textual details about each business object, or any other format.

If an iterative method is used, the selected object may be examined to determine the UPI of the selected object and whether the object has any predecessor and/or successor objects with the same UPI 730. If there are predecessor and/or successor objects with the same UPI, each may be selected 740 to determine whether the predecessor/successor object in turn has any predecessor/successor objects 730. The process is repeated until the complete process instance has been assembled for analysis 750. As previously described, such an iterative method may be more time and/or computationally efficient than other iterative methods that may be used in the absence of a process instance identifier. The process instance may be provided to a user in the same manner as when the direct method is used.

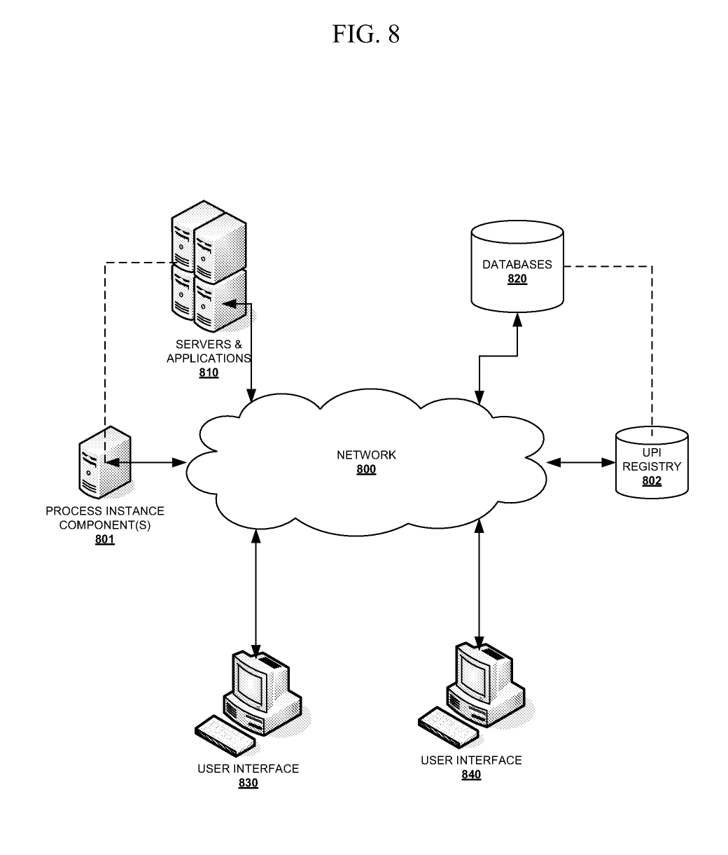

An exemplary system implementing process instance identifiers according to the present invention is shown in FIG. 8. A business system may have one or more servers 810 and databases 820 in communication with one or more user interface terminals 830, 840. Servers in the business system may store and execute business objects, business applications, and other various objects and applications. As previously described, business objects are generated by applications in the business system. As used herein, a business object may be described without reference to an application, though it will be understood that each business object may be generated by and resident in an application. When two or more business objects are described, they may be contained within the same application or different appiucations. The user terminals 830, 840 implement user interfaces to the business system. Process instance components 801, such as the applications necessary to implement process instance identifiers, may be part of the other applications in the system or may be separate components. Similarly, a UPI registry 802 may be a separate storage component or may be implemented as part of other databases in the system. As shown, the various components of the business system may be connected via a network or directly connected. The specific arrangement and topology of servers, applications, systems, communication protocols, and connections are irrelevant to the invention unless specified otherwise herein. When users access the business system via user terminals 830, 840, business objects may be created and used to perform various tasks. As previously described, UPIs may be created by the various applications 801, 810 of the business system. Each process instance may be associated with a UPI, allowing for analysis of the instance Information about UPIs and related business objects may be stored in various databases 802, 820 and other storage mechanisms within the business system.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms,

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A business system comprising:
a process instance identifier registry to store identifiers assigned to process instances executed by the business system; and
a plurality of applications to generate business objects, each application having a database to store data specific to the respective application,
wherein each business object generated by an application stores an internal identifier for use by the generating application and a process instance identifier.

2. The business system of claim 1, wherein when a first business object spawns a second business object, a process instance identifier assigned to the first business object is assigned to the second business object.

3. The business system of claim 1, wherein when a message is sent from a first of the plurality of applications to a second of the plurality of applications, a process instance identifier assigned to a business object in the first application is propagated to a business object in the second application.

4. The business system of claim 1, the process instance identifier registry further to store a record of each business object to which a process instance identifier is assigned.

5. A method of storing process instance information, comprising, responsive to creation of a new business object in a business system:
if the new business object has a predecessor business object, selecting a process instance identifier assigned to the predecessor business object and assigning the process instance identifier associated with the predecessor business object to the new business object; and
if the new business object does not have a predecessor business object, generating a new process instance identifier and assigning the new process instance identifier to the new business object;
wherein the new business object is generated during execution of a process instance, and the process instance identifier assigned to the new business object is assigned to the process instance.

6. The method of claim 5, wherein generating a new process instance identifier comprises responsive to a query sent to a process instance identifier registry, receiving the new process instance identifier from the process instance identifier registry,

7. The method of claim 5, further comprising storing a record of the new business object and the process instance identifier assigned to the new business object in a process instance identifier registry.

8. The method of claim 5, further comprising:
if the new business object has a successor business object, assigning the process instance identifier assigned to the new business object to the successor business object.

9. A method of tracking business information through a network system of business applications, comprising:
at a first one of the applications and responsive to a user request for process instance information associated with a first business object, selecting a process instance identifier assigned to the first business object;
selecting a second business object, wherein the process instance identifier assigned to the second business object is the same as the process instance identifier assigned to the first business object; and
displaying a process instance schematic, wherein the first and second business objects were generated during execution of the process instance.

10. The method of claim 9, further comprising selecting each other business object in the business system associated with the process instance identifier assigned to the first business object.

11. The method of claim 10, wherein the first business object, the second business object, and the other business objects associated with the process instance identifier assigned to the first business object are identified by a single query sent to a process instance registry.

12. The method of claim 9, wherein the process instance schematic includes information identifying a predecessor-successor relationship between the first business object and the second business object.

13. The method of claim 9, wherein the process instance schematic is a graphical representation of the steps performed during execution of the process instance,

14. A machine-readable medium containing program instructions for execution on a processor, which when executed cause the processor to perform:
responsive to creation of a new business object;
if the new business object has a predecessor business object, selecting a process instance identifier assigned to the predecessor business object and assigning the process instance identifier associated with the predecessor business object to the new business object; and
if the new business object does not have a predecessor business object, generating a new process instance identifier and assigning the new process instance identifier to the new business object;
wherein the new business object is generated during execution of a process instance, and the process instance identifier assigned to the new business object is assigned to the process instance.

15. A machine-readable medium containing program instructions for execution on a processor, which when executed cause the processor to perform:
responsive to a user request for process instance information associated with a first business object, selecting a process instance identifier assigned to the first business object;
selecting a second business object, wherein the process instance identifier assigned to the second business object is the same as the process instance identifier assigned to the first business object; and
displaying a process instance schematic, wherein the first and second business objects were generated during execution of the process instance.
